(19) United States
(12) Patent Application Publication
(10) Pub. No.: US 2013/0298510 A1
(43) Pub. Date: Nov. 14, 2013

(54) Cyclone Based On Inlet Particle Regulation

(71) Applicants: Qiang Yang, Shanghai (CN); Hualin Wang, Shanghai (CN); Zhiming Li, Shanghai (CN); Jiangang Wang, Shanghai (CN); Wenjie Lv, Shanghai (CN); Liang Ma, Shanghai (CN)

(72) Inventors: Qiang Yang, Shanghai (CN); Hualin Wang, Shanghai (CN); Zhiming Li, Shanghai (CN); Jiangang Wang, Shanghai (CN); Wenjie Lv, Shanghai (CN); Liang Ma, Shanghai (CN)

(21) Appl. No.: 13/496,278

(22) PCT Filed: Apr. 13, 2011
(86) PCT No.: PCT/CN11/72705

§ 371 Date: Mar. 15, 2012

(30) Foreign Application Priority Data
Nov. 5, 2010 (CN) 201010533906.1

(51) Int. Cl. B04C 5/04; B04C 5/02

(52) U.S. Cl. CPC B04C 5/04; B04C 5/02
USPC 55/456; 55/461; 55/459.1

(57) ABSTRACT

The invention relates to a cyclone based on inlet particle regulation. In particular, the invention provides a cyclone based on inlet particle regulation, comprising an inlet particle regulator and a cyclone, wherein the outlet of the inlet particle regulator is connected to the inlet of the cyclone, and the inlet particle regulator is used to achieve distribution of particles in the inlet cross-section of the cyclone from large to small or from small to large.

### CROSS REFERENCE TO RELATED APPLICATION

The present application claims priority to (is a national stage filing of) PCT Application PCT/CN2011/072705 filed Apr. 13, 2011. The entirety of each of the aforementioned reference is incorporated herein by reference for all purposes.

### BACKGROUND OF THE INVENTION

1. Technical Field

The invention pertains to the field of non-homogeneous solid-liquid separation and solid particle classification, and in particular, relates to a cyclone based on inlet particle regulation that improves the cyclone efficiency of separation and classification by regulating the particles (distributing the particles by size) at the inlet cross-section of the cyclone. The device of the invention may be widely used in energy, chemical engineering, mill run, environmental protection processes, etc. for solid-liquid biphase separation or solid particles classification.

2. Background

A cyclone currently used for non-homogeneous separation and solid particle classification is mainly composed of an inlet, a cylinder section, a cone section, an underflow orifice and an overflow orifice. In order to promote the efficiency and precision of cyclone separation, scholars and researchers in related art have conducted extensive and intensive studies on the structure dimension of these parts of a cyclone. However, these studies are limited exclusively to these parts inherent to a cyclone. For example, as the feed pipe is concerned, such forms of inlet structure as involute type, arc type, helix type, concentric circle type and a type featuring multiple pipes arranged symmetrically have been studied and found to have influence on the separation efficiency, precision and energy consumption of a cyclone. Thus, relevant scholars have proposed and invented new cyclones having a helical guide vane, an eccentric volute feeding structure, etc. Nevertheless, study on or application of a method in which a regulating means is added to the inlet to enforce the separation process by way of regulating the inlet particles, i.e. to improve the separation efficiency and precision of an existing cyclone by predistributing the inlet particles, has not yet been reported.

The separation efficiency and precision of a cyclone separator is affected by three major factors as follows: (1) structure dimension of the cyclone per se; (2) operating parameters; and (3) properties of the material under treatment. The first two aspects have been studied in great deal by scholars and researchers in related art. As to the third aspect, relevant scholars enforce separation by incorporation of fine bubbles or an extractant, i.e. a third phase, in an oil-water (liquid-liquid) cyclone separation process to influence the properties of the material, and improve the efficiency of cyclone separation by addition of a flocculant in a liquid-solid separation process to enlarge solid particle size before the particles enter the cyclone separator, resulting in good application effect. However, for the solid-liquid separation of certain fine slurries, separation precision of lower than 5 μm is difficult to be achieved by an existing conventional cyclone separator, and the separation precision can not be improved by introduction of a third phase to modify the properties of the material. It is no doubt that this is a troublesome problem faced by today's researchers.

Therefore, in view of the problems existing in prior art, there is an urgent need in the art to develop a simple and effective process for improving the efficiency of separation and classification of a cyclone used alone.

### BRIEF SUMMARY OF THE INVENTION

The invention provides a novel cyclone based on inlet particle regulation, eliminating the drawbacks of the prior art.

The invention provides a novel cyclone based on inlet particle regulation, which is comprised of an inlet particle regulator and a cyclone, wherein the outlet of the inlet particle regulator is connected to the inlet of the cyclone, and the inlet particle regulator is used to achieve distribution of the particles from large to small or from small to large in the inlet cross-section of the cyclone.

In an embodiment, the inlet cross-section of the cyclone is rectangular.

In another embodiment, the cross-section of the inlet particle regulator is rectangular.

In another embodiment, the inlet particle regulator regulates the particles at its outlet by centrifugal force.

In another embodiment, the body of the inlet particle regulator is a cylinder or annular cylinder.

In another embodiment, the inlet particle regulator is installed by disposing it near the cyclone inlet or enclosing the outer wall of the cylinder section of the cyclone or the outer wall of the overflow tube.

In another embodiment, the inlet and the outlet of the inlet particle regulator are communicated with the body of the inlet particle regulator in the form of involute, tangent or helix.

In another embodiment, the inlet particle regulator is used as a separate particle classification device or as one of a plurality of particle classification devices that are used in collaboration.

In another embodiment, the inlet of the cyclone is communicated with the cylinder section of the cyclone in the form of involute, tangent or helix.

In another embodiment, the inlet particle regulator distributes the particles along the inlet cross-section of the cyclone inwardly from large to small to improve the classification efficiency of the cyclone, or from small to large to improve the separation efficiency of the cyclone.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a schematic view of a cyclone based on inlet particle regulation according to one embodiment of the invention.

FIG. 2 is a schematic view of a cyclone based on inlet particle regulation according to another embodiment of the invention.

FIG. 3 is a schematic view of a cyclone based on inlet particle regulation according to yet another embodiment of the invention.

FIG. 4 is a schematic view of a cyclone based on inlet particle regulation according to still another embodiment of the invention.

FIG. 5 is a schematic view of a cyclone based on inlet particle regulation according to another embodiment of the invention.

### DETAILED DESCRIPTION OF THE INVENTION

After extensive and intensive study, the inventors have found that large particles and small particles interfere with each other during separation. Specifically, in a cyclone, large solid particles moving toward the side wall can block small particles from moving toward the center, and homogeneous solid particles closer to the side wall at the inlet cross-section can be separated more easily to the underflow orifice. Thus, if the particles are predistributed at the inlet before entering the cyclone so that large particles are close to the center and small particles are close to the side wall, the separation precision of the cyclone will be improved effectively. Contrariwise, if it is desired to improve the classification efficiency of the cyclone, the particles at the inlet may be distributed from large to small in a direction going from the side wall to the center. As a result, the separation precision or classification precision of an existing cyclone with a nominal diameter may be improved effectively. The present invention has thus been accomplished on the basis of the foregoing findings.

The invention provides a cyclone based on inlet particle regulation, which is comprised of an inlet particle regulator and a cyclone, wherein the outlet of the inlet particle regulator is connected to the inlet of the cyclone, and the inlet particle regulator is used to achieve the distribution of the particles from large to small or from small to large in the inlet cross-section of the cyclone, so as to improve the separation performance of the cyclone used alone.

According to the invention, the inlet particle regulator regulates the particles at its outlet with the help of centrifugal force to achieve distribution of the particles at the inlet cross-section of the cyclone from large to small or from small to large inwardly (in a direction going from the side wall to the center of the cylinder section of the cyclone).

According to the invention, the body of the inlet particle regulator is a cylinder or annular cylinder (with an additional solid cylinder or hollow cylinder at the center of a larger cylinder) or any other device for distributing particles by size with the help of centrifugal force, wherein its inlet tube is rectangular or circular, and its outlet and the cyclone inlet, each of which may have a rectangular cross-section, are connected.

According to the invention, the inlet particle regulator is installed by disposing it near the cyclone inlet or enclosing the outer wall of the cylinder section of the cyclone or the outer wall of the overflow tube. Alternatively, in light of an existing cyclone in practical use, it may be designed individually to be installed at the outlet of the existing cyclone to improve separation performance.

According to the invention, the inlet of the cyclone is communicated with the body (cylinder section) of the cyclone in the form of involute, tangent or helix.

According to the invention, the inlet particle regulator may be used as a separate particle classification device or in collaboration with other devices.

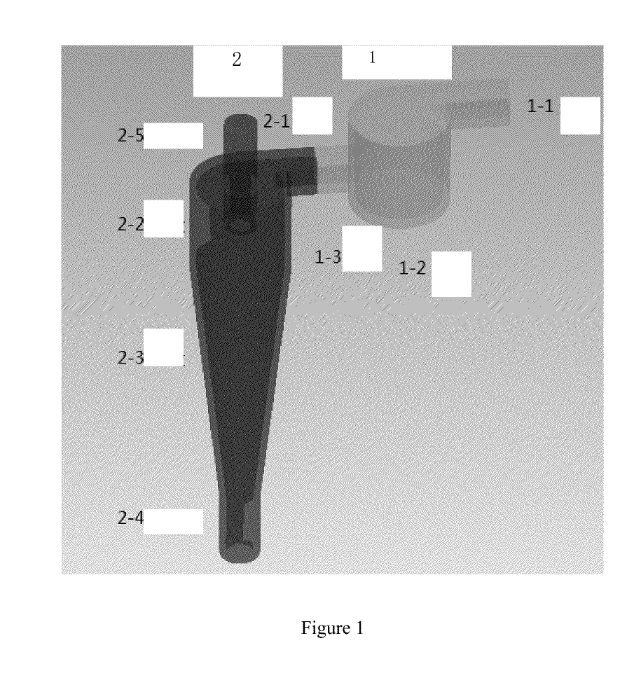

FIG. 1 is a schematic view of a cyclone based on inlet particle regulation according to one embodiment of the invention. As shown in FIG. 1, the cyclone based on inlet particle regulation is mainly composed of an inlet particle regulator 1 and a cyclone 2, wherein the inlet particle regulator 1 is composed of three parts, namely an inlet 1-1 (a rectangular inlet), a body 1-2 (a cylinder section for centrifugal regulation) and an outlet 1-3 (a rectangular outlet); and the cyclone 2 is composed of five parts, namely an inlet 2-1 (a feed tube), a cylinder section 2-2, a cone section 2-3, an underflow orifice 2-4 and an overflow tube 2-5; a solid-liquid feed mixture enters the inlet particle regulator from the inlet 1-1 and passes through the body 1-2, and then the large particles are distributed from large to small in a direction going from the side wall to the center in the cross-section of the outlet 1-3 before entering the cyclone through the cyclone inlet 2-1 connected therewith; the particles in the cross-section of the feed tube may be distributed from large to small or from small to large in a direction going from the side wall to the center, dependent on different separation or classification; and, after entering the cyclone, the mixture is separated through the cylinder section 2-2 and the cone section 2-3, and then the supernatant is discharged from the overflow tube 2-5 while the concentrated liquid containing the solid particles is discharged from the underflow orifice 2-4.

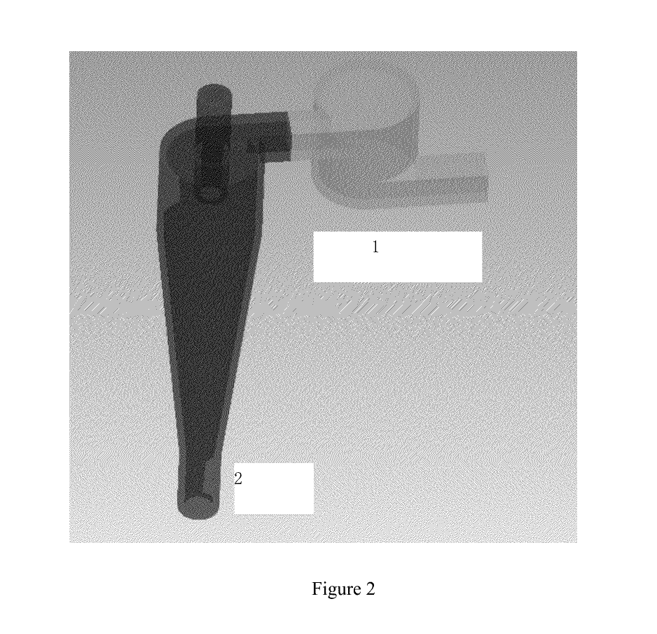

FIG. 2 is a schematic view of a cyclone based on inlet particle regulation according to another embodiment of the invention. As shown in FIG. 2, the cyclone based on inlet particle regulation is mainly composed of two parts, namely a cylindrical inlet particle regulator 1 and a cyclone 2, wherein the inlet and outlet tubes of the inlet particle regulator are both rectangular while its body is a cylinder; the cyclone is composed of two conventional parts; the outer wall of the outlet tube of the inlet particle regulator is joined to the inner wall of the inlet tube of the cyclone; and the inlet tube of the cyclone is connected to the cylinder section in a tangent form; after a solid-liquid biphase mixture passes through the inlet particle regulator, the particles at the cross-section of the outlet tube are distributed from large to small in a direction going from the outer wall to the inner wall; after entering the inlet tube of the cyclone, the particles at the cross-section of the inlet tube are distributed from small to large in a direction going from the outer wall to the inner wall; as a result, a majority of the small particles go to the underflow orifice to be separated out; therefore, the efficiency of the cyclone for separating small particles is improved, and the separation precision of the cyclone is thus promoted.

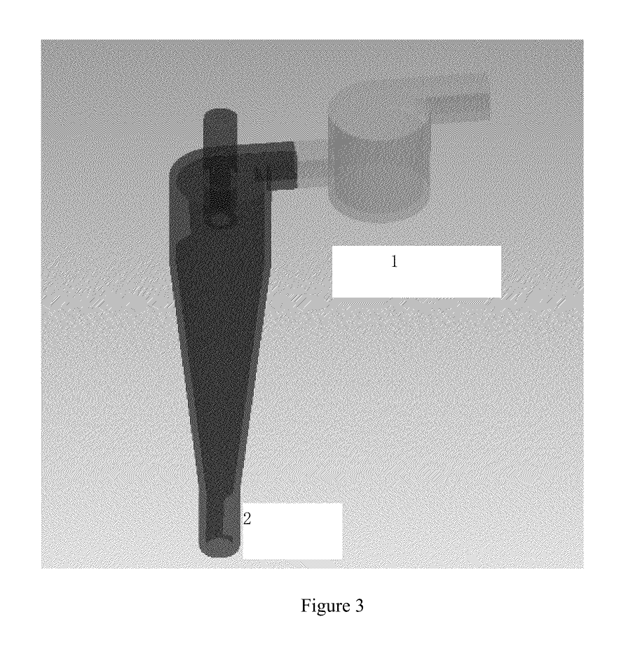

FIG. 3 is a schematic view of a cyclone based on inlet particle regulation according to yet another embodiment of the invention. As shown in FIG. 3, the cyclone based on inlet particle regulation is mainly composed of two parts, namely a cylindrical inlet particle regulator 1 and a cyclone 2, wherein the outer wall of the outlet tube of the inlet particle regulator is joined to the outer wall of the inlet tube of the cyclone; after a solid-liquid biphase mixture passes through the inlet particle regulator, the particles at the cross-section of the outlet tube are distributed from large to small in a direction going from the outer wall to the inner wall; after entering the inlet tube of the cyclone, the particles at the cross-section of the inlet tube are also distributed from large to small in a direction going from the outer wall to the inner wall; and, as a result, a majority of the small particles go to the overflow tube, while a majority of the large particles go to the underflow orifice, leading to improved classification efficiency of the cyclone.

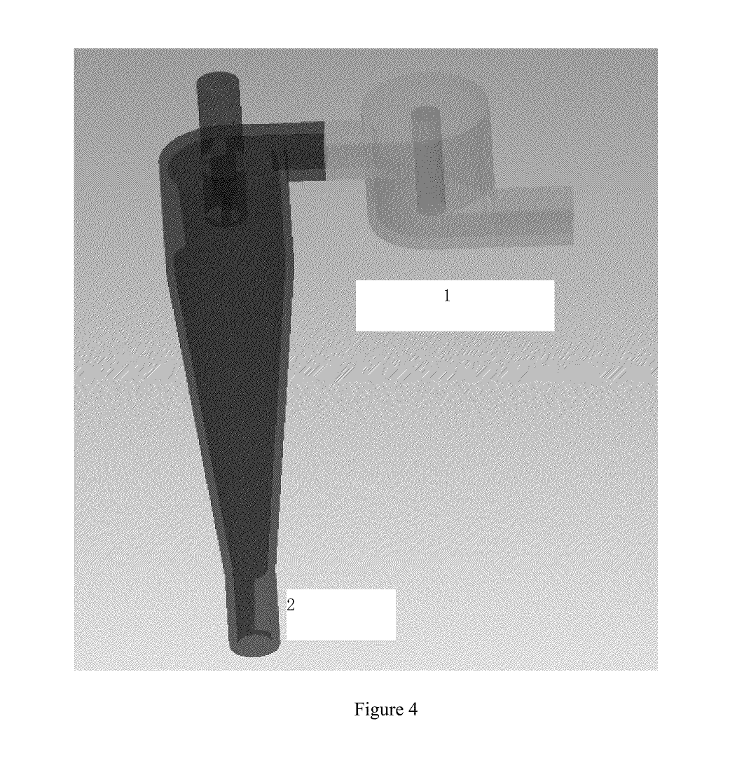

FIG. 4 is a schematic view of a cyclone based on inlet particle regulation according to still another embodiment of the invention. As shown in FIG. 4, the cyclone based on inlet particle regulation is mainly composed of two parts, namely an annularly cylindrical inlet particle regulator 1 and a cyclone 2, wherein the body of the inlet particle regulator is an annular cylinder which is used to achieve distribution of the particles at the cross-section of the outlet tube of the inlet particle regulator from large to small in a direction going from the outer wall to the inner wall.

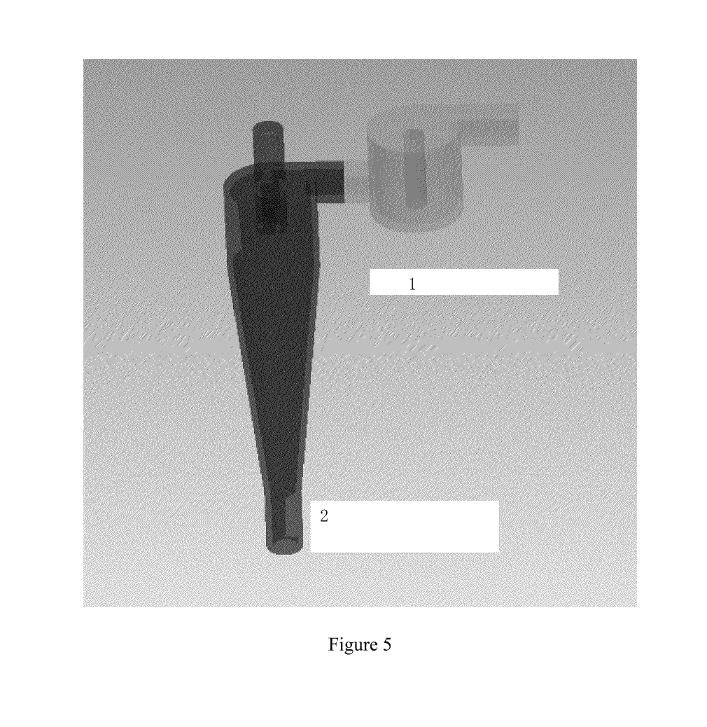

FIG. 5 is a schematic view of a cyclone based on inlet particle regulation according to another embodiment of the invention. As shown in FIG. 5, the cyclone based on inlet particle regulation is mainly composed of two parts, namely an annularly cylindrical inlet particle regulator 1 and a cyclone 2, wherein the body of the inlet particle regulator is an annular cylinder which is used to achieve distribution of the particles at the cross-section of the outlet tube of the particle regulator from large to small in a direction going from the outer wall to the inner wall.

As just some advantages that may be achieved in accordance with different embodiments of the invention, an inlet particle regulator is combined with an existing cyclone organically to enhance the separation and classification efficiency of the cyclone by regulating the particles (distributing the particles by size) at the cross-section of the cyclone inlet, so that the separation performance of the cyclone used alone is improved in great deal. Such a design is advantageous due to its simple structure and high separation efficiency. Based upon the disclosure provided herein, one of ordinary skill in the art will recognize other advantages either in place of the aforementioned or in addition to the aforementioned that may be achieved in accordance with different embodiments of the present invention.

### EXAMPLES

The invention will be further illustrated with reference to the following specific Examples. However, it is to be appreciated that these Examples are only intended to demonstrate the invention without limiting the scope of the invention. The test methods in the following Examples for which no specific conditions are indicated will be carried out generally under conventional conditions or under those conditions suggested by the manufacturers. Unless otherwise specified, all percentages and parts are based on weight.

### Example 1-1

This Example demonstrates a method for improving the separation precision of a cyclone without a particle regulator. As shown in FIG. 2, two parts composed of a cylindrical inlet particle regulator and a cyclone were used, wherein the inlet and outlet tubes of the inlet particle regulator were both rectangular while its body was a cylinder; the cyclone was composed of conventional parts; the outer wall of the outlet tube of the inlet particle regulator was joined to the inner wall of the inlet tube of the cyclone; and the inlet tube of the cyclone was connected to the cylinder section in a tangent form; after a solid-liquid biphase mixture passed through the inlet particle regulator, the particles at the cross-section of the outlet tube were distributed from large to small in a direction going from the outer wall to the inner wall; after entering the inlet tube of the cyclone, the particles at the cross-section of the inlet tube were distributed from small to large in a direction going from the outer wall to the inner wall; and, as a result, a majority of the small particles went to the underflow orifice to be separated out. Therefore, the efficiency of the cyclone for separating small particles was improved, and the separation precision of the cyclone was thus promoted.

### Example 1-2

This Example demonstrates a method for improving the classification efficiency of a cyclone without a particle regulator. As shown in FIG. 3, two parts composed of a cylindrical inlet particle regulator and a cyclone were used. This Example was different from Example 1-1 in that the outer wall of the outlet tube of the inlet particle regulator was joined to the outer wall of the inlet tube of the cyclone. After a solid-liquid biphase mixture passed through the inlet particle regulator, the particles at the cross-section of the outlet tube were distributed from large to small in a direction going from the outer wall to the inner wall. After entering the inlet tube of the cyclone, the particles at the cross-section of the inlet tube were also distributed from large to small in a direction going from the outer wall to the inner wall. As a result, a majority of the small particles went to the overflow tube, while a majority of the large particles went to the underflow orifice, leading to improved classification efficiency of the cyclone.

### Example 2-1

This Example demonstrates a method for improving the separation precision of a cyclone without a particle regulator. As shown in FIG. 4, two parts composed of an annularly cylindrical inlet particle regulator and a cyclone were used. This Example was different from Example 1-1 in that the body of the inlet particle regulator was an annular cylinder which was used to achieve distribution of the particles at the cross-section of the outlet tube of the inlet particle regulator from large to small in a direction going from the outer wall to the inner wall.

### Example 2-2

This Example demonstrates a method for improving the classification efficiency of a cyclone without a particle regulator. As shown in FIG. 5, two parts composed of an annularly cylindrical inlet particle regulator and a cyclone were used. This Example was different from Example 1-2 in that the body of the particle regulator was an annular cylinder which was used to achieve distribution of the particles at the cross-section of the outlet tube of the particle regulator from large to small in a direction going from the outer wall to the inner wall.

### Example 3

This Example demonstrates a method for improving the classification efficiency of a cyclone without a particle regulator. This Example was different from Example 1-1 in that the body of the inlet particle regulator was an annular cylinder enclosing the overflow tube of the cyclone, and the lower helical tangent outlet was connected to the inlet tube of the cyclone.

### Example 4

This Example demonstrates a method for improving the classification efficiency of a cyclone without a particle regulator. This Example was different from Example 1-1 in that the body of the inlet particle regulator was an annular cylinder enclosing the cylinder section of the cyclone, and the upper helical tangent outlet was connected to the inlet tube of the cyclone.

All of the literatures mentioned in the invention are incorporated herein by reference, as if each of them were independently incorporated herein by reference. In addition, it is to be understood that, after reading the above teachings of the invention, persons skilled in the art can make various changes or modifications to the invention, and these equivalents are to be included in the scope defined by the appended claims as well.

It will be appreciated that various modifications can be made to the described embodiments without departing from the spirit and scope of the present invention. In conclusion, the invention provides novel systems, devices, methods and arrangements for cyclone based on inlet particle regulation. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A cyclone based on inlet particle regulation, comprised of an inlet particle regulator and a cyclone, wherein an outlet of the inlet particle regulator is connected to an inlet of the cyclone, and the inlet particle regulator is used to achieve distribution of particles in the inlet cross-section of the cyclone from large to small or from small to large.

2. The cyclone based on inlet particle regulation of claim 1, wherein an inlet cross-section of the cyclone is rectangular.

3. The cyclone based on inlet particle regulation of claim 1, wherein a cross-section of the inlet particle regulator is rectangular.

4. The cyclone based on inlet particle regulation of claim 2, wherein a cross-section of the inlet particle regulator is rectangular.

5. The cyclone based on inlet particle regulation of claim 1, wherein the inlet particle regulator regulates the particles at its outlet by centrifugal force.

6. The cyclone based on inlet particle regulation of claim 1, wherein a body of the inlet particle regulator is a cylinder or annular cylinder.

7. The cyclone based on inlet particle regulation of claim 1, wherein the inlet particle regulator is installed by disposing it near an inlet of the cyclone or enclosing an outer wall of a cylinder section of the cyclone or an outer wall of an overflow tube.

8. The cyclone based on inlet particle regulation of claim 1, wherein an inlet and an outlet of the inlet particle regulator are communicated with the body of the inlet particle regulator in the form of involute, tangent or helix.

9. The cyclone based on inlet particle regulation of claim 1, wherein the inlet particle regulator is used as a separate particle classification device or as one of a plurality of particle classification devices that are used in collaboration.

10. The cyclone based on inlet particle regulation of claim 1, wherein an inlet of the cyclone is communicated with a cylinder section of the cyclone in the form of involute, tangent or helix.

11. The cyclone based on inlet particle regulation of claim 1, wherein the inlet particle regulator distributes the particles along the inlet cross-section of the cyclone inwardly from large to small to improve the classification efficiency of the cyclone, or from small to large to improve the separation efficiency of the cyclone.
